(19) United States
(12) Patent Application Publication
(10) Pub. No.: US 2017/0210447 A1
(43) Pub. Date: Jul. 27, 2017

(54) Wave Amplification Power-Generating Boat

(71) Applicant: Wenbin CHEN, Guangzhou (CN)

(72) Inventor: Wenbin CHEN, Guangzhou (CN)

(21) Appl. No.: 15/328,422

(22) PCT Filed: Aug. 14, 2015
(86) PCT No.: PCT/CN2015/000588

§ 371 Date: Jan. 23, 2017

(30) Foreign Application Priority Data
Aug. 26, 2014 (CN) 201420484161.8

(51) Int. Cl. B63B 35/44; H02K 7/18; B63H 5/07; F03B 13/22; B63B 1/14; B63B 21/20

(52) U.S. Cl. CPC B63B 35/44; B63B 1/14; B63B 21/20; B63H 5/07; F03B 13/22; H02K 7/1853; B63B 2035/4466; B63B 2001/145

(57) ABSTRACT

Disclosed is a wave amplification power-generating boat, comprising float systems (1), a support system (2), a hydraulic turbine power-generating system (3) or a float power-generating system (7) or a canard-type power-generating system (8), a wind rudder system (4), a propeller (5), a mooring system (6) and a wave detector system (9). The float systems (1) are capable of moving on a support; the support system (2) is used to connect the float systems (1) at two ends, with the hydraulic turbine power-generating system (3) or the float power-generating system (7) or the canard-type power-generating system (8) installed in the middle, and installing the wind rudder system (4), the propeller (5), the mooring system (6), and the wave detector system (9); the hydraulic turbine power-generating system (3), etc., works and generates power by utilizing amplified waves in the middle of a boat; and the wave detector system (9) is used to detect and compute an average wave length, to adjust in a timely manner a distance between floating points (101) at two ends to be as close to the wave length as possible, and adjust the direction of the boat to be consistent with that of the wave. The wave amplification power-generating boat enables a high wave energy conversion efficiency, and has a very strong ability to wind and waves.

### TECHNICAL FIELD

This invention involves a power generating device with wave energy, particularly a high-efficiency and low-cost wave amplitude power generating ship with very strong capacity resisting wind and wave.

### TECHNICAL BACKGROUND

The wave energy power generating devices in the current market have the following problems in the actual application: to stabilize the platform, it has to be fixed with the pile or by fabricating a floating body being multiple times more than the wavelength, for example, a turbine wave power generating device under the patent number of ZL201220106154.5 announced on Oct. 3, 2012, which is characterized that the power generating device can only use the original wave height, and capture the wave energy of 0-1 time wave height, instead of the wave energy of 1-2 times of the wave height, that is, the wave cannot be magnified for use.

At present, such application does not have obvious effect in case of small wave and does not have high power generation efficiency. While the average wave height in the coastal area of China is only 1 m. So its economic value is limited.

The development trend for wave energy power generation will be: development of high-efficiency wave amplitude power generating device with very strong capacity resisting wind and wave. Only high-efficiency wave amplitude power generating device with very strong capacity resisting wind and wave can make full use of the wave energy, adapt to the harsh marine conditions, and guarantee that the power generating device will not be destroyed by heavy wind and wave; it is characterized by simple design, so it is possible to ensure low cost and embody the commercial use value.

### INVENTION CONTENTS

This invention aims to provide a high-efficiency wave power generating device with very low cost and very strong capacity resisting wind and wave, which shall still work for the small wave. The offshore platform is fixed with the piles, or the floating body being many times more than that of the wavelength is stable for the wave, and the water turbine installed on the platform or floating body can only use the wave height of 0-1 time, which results in low efficiency. This invention has resolved this lingering problem.

The working principle of this invention:

Two persons carry an object, whose distance to the ground on the continuous equal wave path will receive the upward and downward displacement of two times of the wave height. As we know, since two persons carry an object, the object in the middle will move with two persons upward or downward; if the distance of two persons is equal to the continuous wave of the ground surface, the intermediate object will go uphill and downhill with two persons; when two persons stand in the wave valley, the distance of the intermediate object to the wave peak is one wave height shorter than that of the walk on the flat surface. When two persons stand in wave peak, the distance of the intermediate object to the wave peak is one wave height bigger than that of the walk on the flat surface. That is, the distance change from the intermediate object to the ground is two times of wave height, instead of one time.

Similarly, the support 2 is used to connect the floating bodies 120 on both ends, the length 102 of every floating body 120 is much smaller than the wavelength 010, the distance 09 between two floating bodies is equivalent to the wavelength 010, as shown in FIGS. 1, 2, 3 and 6. At the center point 04 of the support 2 connecting two floating bodies 120, there will be the wave height of 1-2 times, just as two persons carry an object and walk on the average continuous wave path. The water turbine 301 installed in the middle of the support 2 will obtain the wave energy generated by 1-2 times of the wave height, thus overcoming the defect that only the wave height of 0-1 time can be used for general platform, and capable of improving the efficiency to a large extent.

As shown in FIGS. 1 and 2, the floating body 120 with the length 102 much smaller than the wave length 010 will float with the wave forever, just like a person walking on the wave surface, whose floating point 101, that is, the center of gravity, will stay on the water surface forever; while the water surface changes in sinusoidal curve, so the height of the floating point 101 changes in the sinusoidal form. The support 2 is used to connect the floating bodies 120 on both ends, the distance 09 between two floating bodies is equivalent to the wavelength 010; as shown in FIG. 3, in case of the wave situation 05, the center of gravity 101 of the floating bodies 120 on both ends is situated in the valley, and the middle position 04 is in the peak; in case of the wave situation 06, the center of gravity 101 of the floating bodies 120 on both ends is situated in the peak, and the middle position 04 is in the valley. In the wave with constant change, the middle position 04 will obtain the wave height of two times, that is, the height change of the wave in this position is two times of the wave height. The wavelength constantly changes, as shown in FIG. 4, sometimes the wavelength 010 of the wave 07 is bigger than the distance 09 of two floating points 101, and the amplitude ship will move in the same direction as that of the wave in the middle position 04, when the wave height in the middle position 04 is smaller than one time; as shown in FIG. 5, sometimes the wavelength 010 of the wave 08 is smaller than the distance 09 of two floating points 101, when the wave height in the middle position 04 is smaller than two times.

As shown in FIGS. 1 and 6, in case of the wave situation 05, the floating point 101 is situated in the valley, and the middle position 04 is in the peak, so the water level in the cylinder 306 installed here is flush with the peak; when the floating point 101 changes from the valley to peak, it will push the ship to rise, when the water level at the middle position 04 falls, and the water in the cylinder 306 flows out from the water turbine 301 installed below the cylinder 306, as 311, to push the water turbine 301 to rotate and act clockwise. When the floating point 101 changes to peak, in case of the wave situation 06, the middle position 04 of the ship hull is in the valley, where the water level in the cylinder 306 installed here is flush with the valley; when the floating point 101 changes from the peak to valley, the gravity drives the ship to press downward, when the water level at the middle position 04 rises, the water in the cylinder 306 flows in from the water turbine 301 installed below the cylinder 306, as 310, to push the water turbine 301 to rotate and act counterclockwise.

The rotation of the water turbine clockwise and counterclockwise cannot drive the work of the motor 304, when the moment of the water turbine 301 is transmitted through the axis 302 to the axial direction adjuster 303, it will form the unidirectional axis motion at uniform speed, thus driving the generator 304 to act and generate power.

To stably obtain the maximum wave energy, it is required to constantly adjust the distance 09 of two floating points 101, so that this distance will be close to the average wavelength 010 in constant change in the local sea area, thus the wave height in the middle position 04 can be close to 2 times. There are two methods to adjust the distance 09 of two floating points 101: first, manual adjustment; second, automatic adjustment.

This invention has the following beneficial effects,
1. Using the phase principle, this invention enables 1-2 times of wave height at the middle position 04 of the support 2 of the power generating ship, thus the water turbine, floating body and duck body installed here can largely increase the wave energy available for power generation.
2. The average wave height in the coastal area of China is only 1 m. If the device makes sure that the wave energy at the 1-2 m wave height can be captured on this basis, it will largely increase the viability of wave power generation for commercial use, and thus wave power generation for commercial use in China will become possible.

### DESCRIPTION OF THE ATTACHED DRAWINGS

FIG. 1 shows the overall structural schematics of this invention.

FIG. 2 shows the breakdown drawing of the floating body system 1.

FIG. 3 shows the principle diagram of the wave amplitude in case that the distance 09 of two floating points 101 is equal to the wavelength 010.

FIG. 4 shows the principle diagram of the ship moving in the same direction as that of the wave in case that the distance 09 of two floating points 101 is smaller than the wavelength 010.

FIG. 5 shows the principle diagram that the wave height in the middle of the ship is smaller than two times of the wave height in case that the distance 09 of two floating points 101 is bigger than the wavelength 010.

FIG. 6 shows the schematics of the front and top views of the turbine power generation system 3.

FIG. 7 shows the schematics of the wind rudder system 4.

FIG. 8 shows the schematics of the wave detector system 9.

FIG. 9 shows the schematics of the twin-hull wave amplitude power generating ship.

FIG. 10 shows the position drawing of the floating body power generation system 7 on the support 2.

FIG. 11 shows the breakdown drawing of the floating body power generation system 7.

FIG. 12 shows several shape drawings of the power generation floating body 701.

FIG. 13 is the position drawing of the duck-type power generation system 8 on the support 2.

FIG. 14 is the breakdown drawing of duck-type power generation system 8.

### DETAILED IMPLEMENTATION MEANS

Further explanation will be given on this invention in combination with the attached drawings and the implementation examples below.

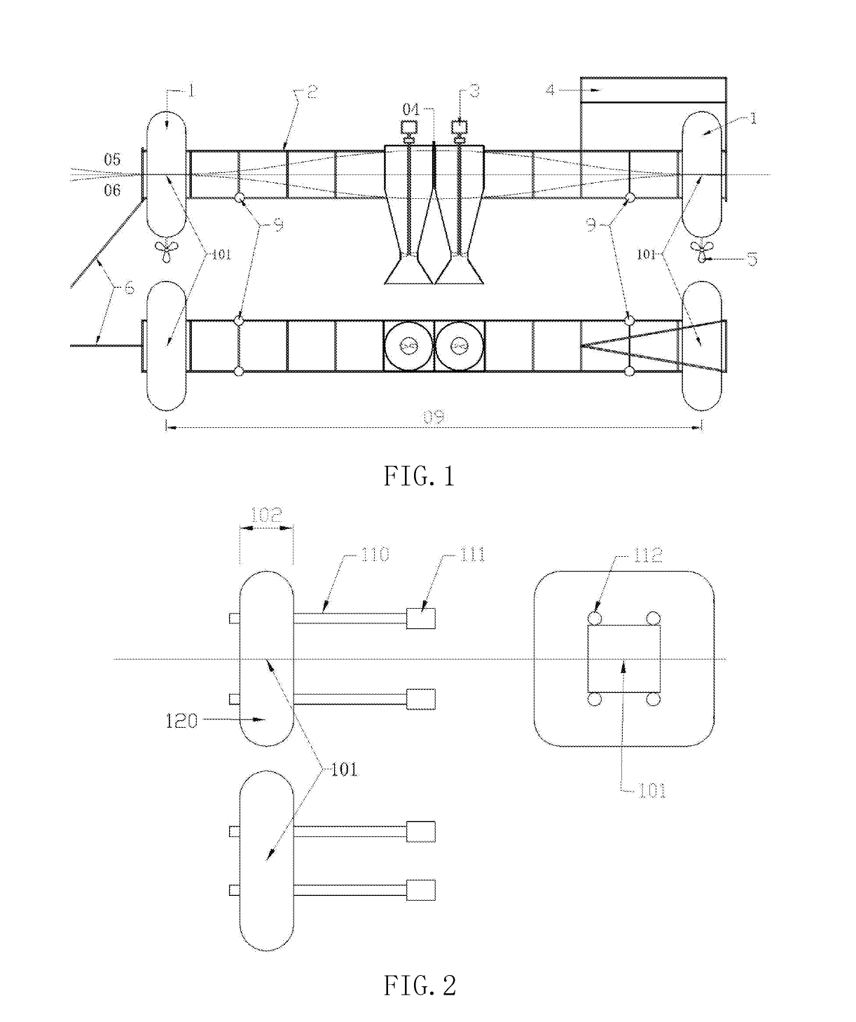

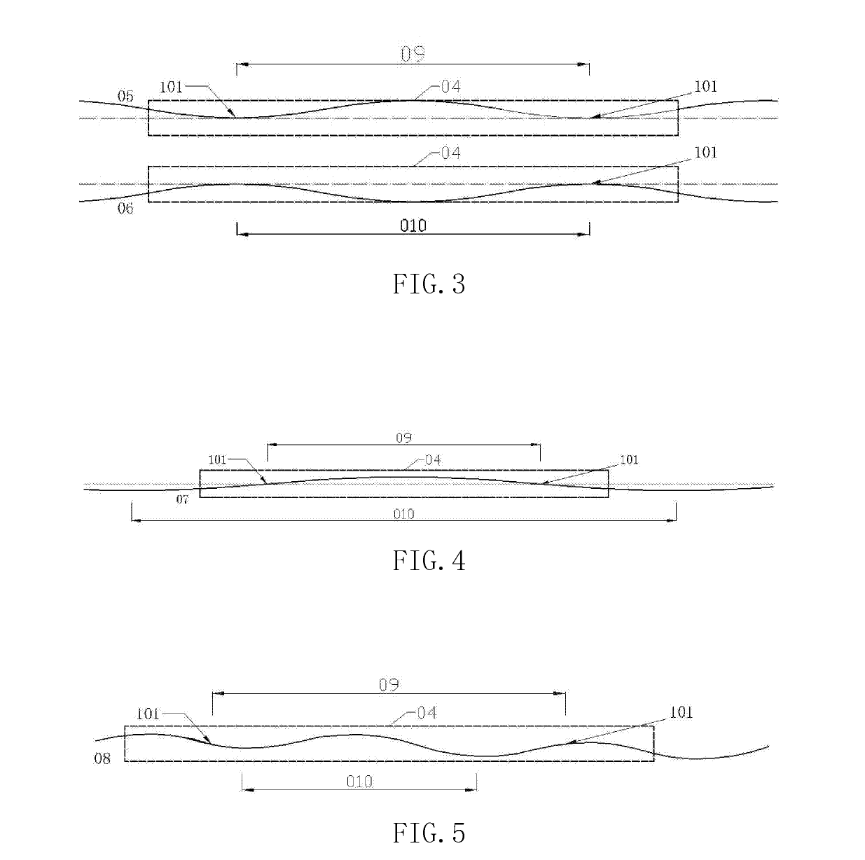

As shown in FIG. 1, this implementation example consists of the floating body system 1, the support system 2, turbine power generation system 3, wind rudder system 4, propeller 5, anchor chain system 6 and wave detector system 9.

As shown in FIG. 2, the floating body system 1 consists of the floating body 120, screw 110, motor 111, and nut 112. The floating body 120 is hollow and toroidal, and may also be toroidal and square ring shapes created by the polygonal shapes, such as square shape; the motor 111 is fixed on the support 2, the screw 110 is connected with the motor 111; and the nut 112 is fixed in the floating body 120. When the motor 111 is energized, it can realize rotation clockwise and counterclockwise; the rotation of the motor 111 will drive the rotation of the screw 110, whose rotation enables the adjustment of the distance from the nut 112 to the motor 11, while the motor 111 is fixed on the support 2, thus capable of adjusting the distance between the floating bodies 120 on both ends.

The said floating body 121 may also be used with the stem and stern fixing mode, as shown in FIG. 9.

The said support system 2 may be metallic frame, as shown in FIGS. 1 and 7; and may also include the ship hull, side wall and internal structure, as shown in FIG. 9.

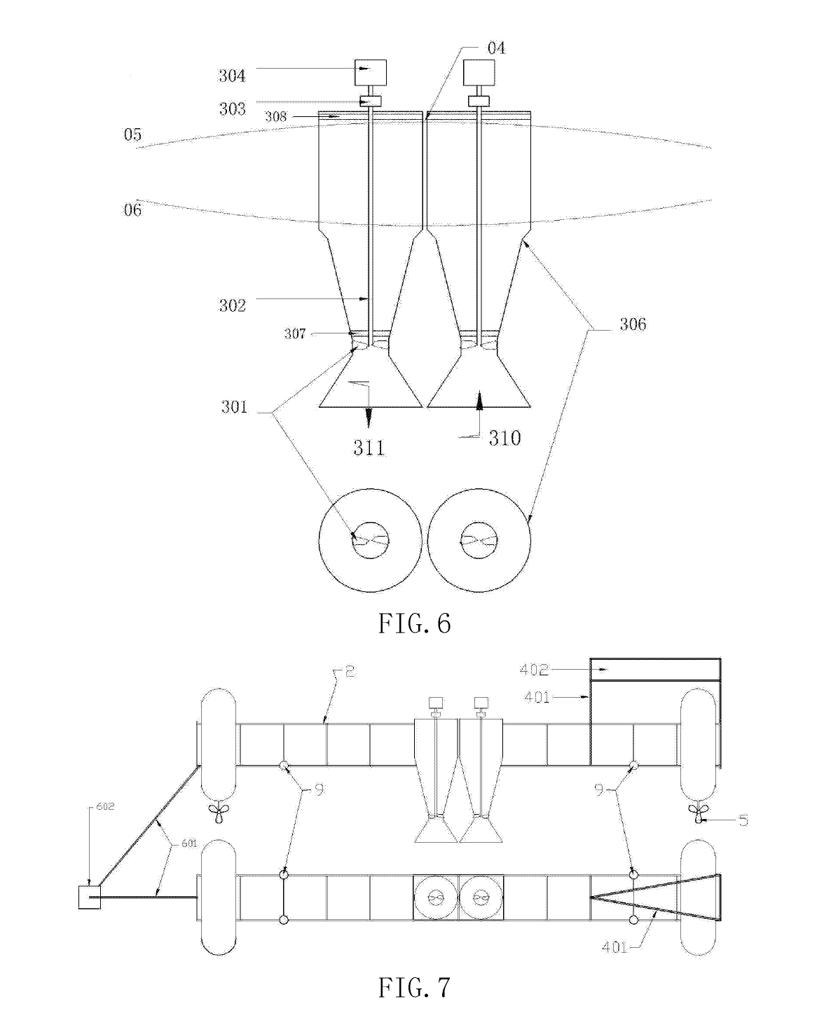

As shown in FIG. 6, the turbine power generating system 3 consists of water turbine 301, axis 302, moment direction adjuster 303, generator 304, cylinder 306, lower bracing of axis 307 and upper bracing of axis 308. The water turbine 301 is fixed in the lower part of axis 302, the lower bracing of axis 307 limits the axis 302 below the cylinder 306, the upper bracing of axis 308 limits the axis 302 above the cylinder 306, and the upper part of the axis 302 is connected with the moment direction adjuster 303; the moment obtained by the water turbine 301 from the wave is transmitted to the axis 302 and changes in the sinusoidal form to the extent not allowing the generator to work. After the adjustment by the moment direction adjuster 303, the previous moment becomes the unidirectional moment at uniform speed, and then transmitted to the generator 304, for power generation. Cylinder 306 looks like the funnel, in which water flows upward and downward to push the water turbine 301 to rotate clockwise and counterclockwise; cylinder 306 is installed between the support system 2. One support 2 may be installed with two cylinders 306, as shown in FIG. 1, and may also be installed with 200 cylinders 306 to form the matrix layout, as shown in FIG. 9.

As shown in FIG. 7, the said wind rudder system 4 consists of framework 401 and canvas 402. The framework 401 is welded on the support 2, situated in or near the stern position. The anchor chain 601, support 2 and wind rudder 4 form a structure similar to the vane, and the hull of the ship looks like the vane, the stem drawn by the anchor chain 601 will just point to the corning direction of wind forever, while the wind rudder 4 will function as the tail of the vane, pointing to the running direction of wind, so that the direction of the support 2 is consistent with the corning direction of the wind always, thus consistent with the wave direction. Since the big wave is mostly caused by wind, its direction is basically consistent with that of wind.

Motorized ship direction adjustment: when the direction of the ship is consistent with that of the wave, probes 901 in the same position installed on both sides of the support 2 will sense the pressure of wave at the same time; when the direction of the ship is inconsistent with that of the wave, probes 901 on both sides of the support 2 will sense the pressure of wave not at the same time, when the computer 902 will automatically send the instruction to start propeller 5 in the bottom of the ship so that the ship makes the horizontal rotation movement, thus the direction of the ship is adjusted to be consistent with that of the wave; when the direction is consistent, the rotation of propeller 5 will be stopped. It is adjusted every 1-10 minutes, thus capable of constantly automatic adjustment to be consistent with the wave direction.

The said propeller 5 is of suspension type, capable of 360-degree rotation around the suspension shaft; so the propeller 5 cannot only be used as the motive for forward movement of the ship, but also be used as the direction rudder of the ship.

As shown in FIG. 7, the anchor chain system 6 consists of gravity anchor 602 and anchor chain 601. The gravity anchor 602 sinks into the bottom of the sea, and one end of the anchor chain 601 is linked with the gravity anchor 602 and the other end is connected with the upper support 2, thus the ship can be fixed at certain position in the sea.

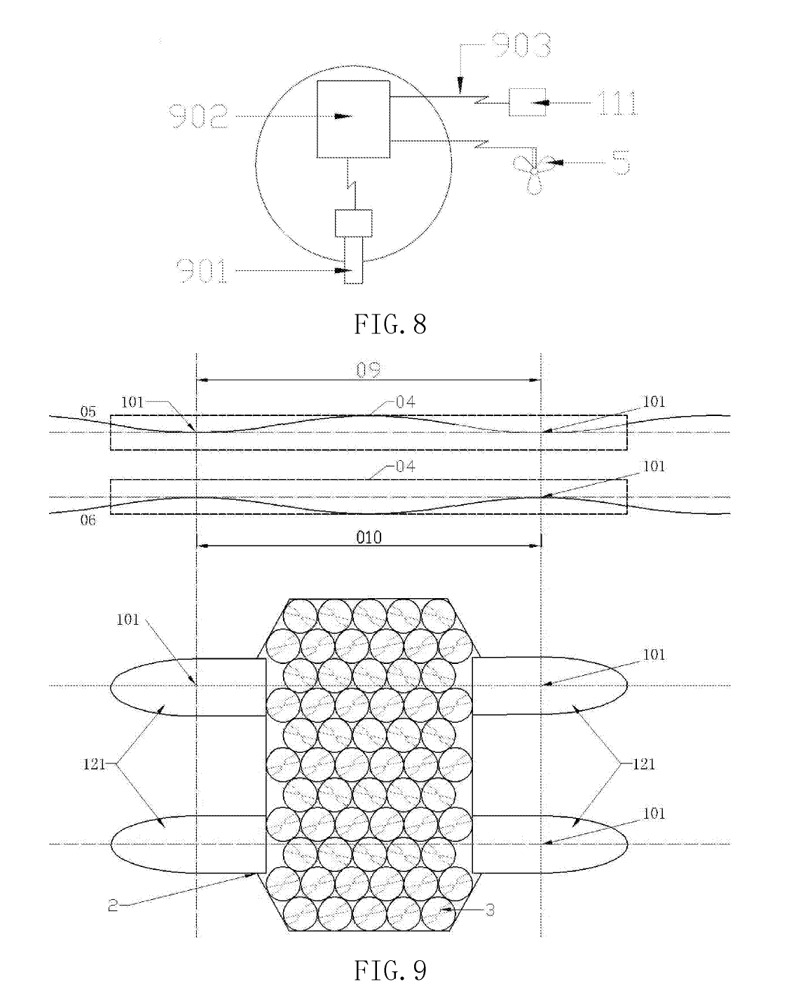

As shown in FIG. 8, wave detector system 9 consists of probe 901, computer 902, electric wire 903, the computer 902 connects with probe 901, and also connects with motor 111 and propeller 5. Probe 901 constantly detects the change of wave, and computer 902 calculates the average wavelength within certain time period, such as 1-5 minutes, then regularly adjust the distance 09 of two floating points 101 by changing the positive and negative rotating directions of the motor 111, so that it is as close as possible to the wavelength 010. So the turbine power generation system 3 installed in the middle of the support 2 can obtain the energy nearly two times of the wave height, thus generating the maximum power.

In case that the wave detector system 9 is not installed, manual clicking of the pushbutton can also change the positive and negative rotating directions of the motor 111, This involves manual control of the distance to the floating point 101, applicable for the small-sized power generating devices.

In the middle position 04 of wave amplitude power generating ship, there shall be two times of the wave height. The ship direction shall be consistent or nearly consistent with the wave direction, so that the floating bodies 120 on both ends can be in the peak as shown in 05 and in the valley as shown in 06, for which the ship direction shall be adjusted constantly.

Thus, the propeller 5 and computer 902 installed in the bottom of the ship make the power generating ship float in the designated sea area and make the positive direction of the hull is always in a straight line with the wave direction under the assistance of the satellite navigation, guaranteeing that the wave in the middle of the hull achieves the maximum amplitude.

### Implementation Example II

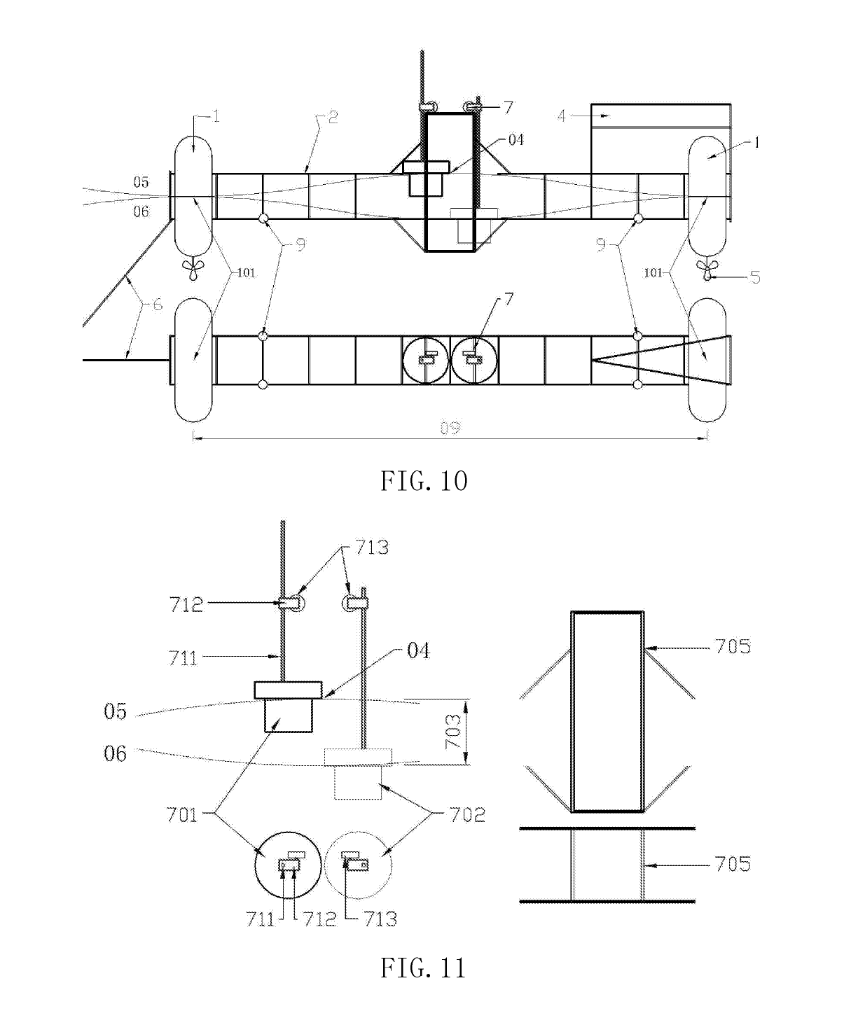

As shown in FIGS. 10 and 11, this implementation example consists of the floating body system 1, the support system 2, floating body power generation system 7, wind rudder system 4, propeller 5, anchor chain system 6 and wave detector system 9.

As shown in FIG. 2, the floating body system 1 consists of the floating body 120, screw 110, motor 111, and nut 112. The floating body 120 is hollow and toroidal, and may also be toroidal and square ring shapes created by the polygonal shapes, such as square shape; the motor 111 is fixed on the support 2, the screw 110 is connected with the motor 111; and the nut 112 is fixed in the floating body 120. When the motor 111 is energized, it can realize rotation clockwise and counterclockwise; the rotation of the motor 111 will drive the rotation of the screw 110, whose rotation enables the adjustment of the distance from the nut 112 to the motor 11, while the motor 111 is fixed on the support 2, thus capable of adjusting the distance between the floating bodies 120 on both ends.

The said support system 2 is the metallic frame, as shown in FIGS. 1 and 7.

As shown in FIG. 11, the floating body power generation system 7 consists of power generation floating body 701, supporting frame 705, gear rack 711, gear rack and axial motion converter 712 and generator 713. The hole is made in the middle of power generation floating body 701, which is limited by the supporting frame 705 on the support 2; or power generation floating body 701 is installed with the pulleys on four corners, and the supporting frame 705 are installed with the guide rails on four sides of power generation floating body 701, thus the power generation floating body 701 can make the up-and-down motion with the wave; the supporting frame 705 is welded on the support 2; power generation floating body 701 is installed with gear rack 711, which runs through the gear rack and axial motion converter 712, then the output axis of gear rack and axial motion converter 712 is connected with the generator 713. Gear rack and axial motion converter 712 and generator 713 are fixed on the supporting frame 705 separately.

When the floating body 120 is in the valley, as in the situation of the wave 05, the middle position 04 of the support 2 is in the peak, then power generation floating body 701 changes from the valley to peak, to drive the rise of the support 2, while the water level in the middle position 04 of the support 2 changes from peak to valley and the power generation floating body 701 also changes from the peak to valley with the wave. But the gear rack and axial motion converter 712 and generator 713 installed on the supporting frame 705 rise with the support 2, thus the gear rack 711 will produce the relative motion with the gear rack and axial motion converter 712, drive the rotation of the output shaft, thus driving the rotation of the generator 713 for power generation; the gear rack and axial motion converter 712 can change the linear motion of the gear rack 711 to the unidirectional rotation motion of the output shaft, meeting the need of the generator 713, thus capable of generating power; when the power generation floating body 701 changes to valley and is in the position of power generation floating body 702, then 703 represents its acting process; now the floating body 120 is in the peak, as the case in the situation of wave 06.

Wave is in constant change. The floating body 120 changes from peak to valley, as in the situation of wave 06, to drive the dropping of the support 2, while the water level in the middle position 04 of the support 2 changes form valley to peak. The power generation floating body 701 installed in the middle position 04 also changes from the valley to peak, while the gear rack and axial motion converter 712 and generator 713 installed on the supporting frame 705 fall with the support 2, thus gear rack 711 and gear rack and axial motion converter 712 will produce the relative motion, to drive the rotation of the output shaft, thus driving the rotating power generation by the generator 713. When power generation floating body 701 changes from the valley to peak, it is in the position of power generation floating body 701. At this moment, the power generation floating body 701 finishes one wave period, power generation floating body 701 repeats such circulation like this, and generator 713 can constantly generate power.

To increase the output power of the floating force, it is required to increase the floating force of the power generation floating body 701, and the projection area of the upper part of the water level of the floating body shall be 0.3-50 times bigger than the projection area of the lower part of the water level. When the power generation floating body 701 (702 position) changes from the valley to peak, the water level at the floating body will rise due to the resistance of the generator; the bigger the area of the part of the floating body being submerged, the bigger the floating force that can be provided within shorter time, thus overcoming the resistance of the generator in a timely manner, and making the floating body act; therefore, only by this means, the acting of the floating body will not significantly lag behind the change of wave, thus achieving high efficiency.

To increase the output power of the gravity, it is required to increase the gravity of the power generation floating body 701 in the air. The draught of power generation floating body 701 shall be more than 0.5-50 times of the short axis or short-side length of the part below the water level. When the power generation floating body 701 changes from the peak to valley, the water level at the floating body will drop due to the pulling force (resistance) of the generator; the larger the weight of the floating body exposed in the air, the bigger the acting gravity that can be provided within shorter time, thus capable of overcoming the pulling force (resistance) of the generator in a timely manner, and making the power generation floating body 701 act.

The said gear rack 711 may be replaced by the hydraulic lever, the gear rack and axial motion converter 712 may be replaced by the hydraulic motor; when power generation floating body 701 makes the up-and-down motion with the wave, it will drive one end of the hydraulic lever to make the reactive motion, thus generating the varying hydraulic pressure; while the varying hydraulic pressure will drive the hydraulic motor, then drive the rotation of generator 713 for power generation.

One or 2-200 floating body power generation systems 7 may be installed on the support system 2, with two systems shown in FIG. 10.

As shown in FIG. 7, the said wind rudder system 4 consists of framework 401 and canvas 402. The framework 401 is welded on the support 2, situated in or near the stern position. The anchor chain 601, support 2 and wind rudder 4 form a structure similar to the vane, and the hull of the ship looks like the vane, the stem drawn by the anchor chain 601 will just point to the coming direction of wind forever, while the wider rudder 4 will function as the tail of the vane, pointing to the running direction of wind, so that the direction of the support 2 is consistent with the coming direction of the wind always, thus consistent with the wave direction. Since the big wave is mostly caused by wind, its direction is basically consistent with that of wind.

Motorized ship direction adjustment: when the direction of the ship is consistent with that of the wave, probes 901 in the same position installed on both sides of the support 2 will sense the pressure of wave at the same time; when the direction of the ship is inconsistent with that of the wave, probes 901 on both sides of the support 2 will sense the pressure of wave not at the same time, when the computer 902 will automatically send the instruction to start propeller 5 in the bottom of the ship so that the ship makes the horizontal rotation movement, thus the direction of the ship is adjusted to be consistent with that of the wave; when the direction is consistent, the rotation of propeller 5 will be stopped. It is adjusted every 1-10 minutes, thus capable of constantly automatic adjustment to be consistent with the wave direction.

The said propeller 5 is of suspension type, capable of 360-degree rotation around the suspension shaft; so the propeller 5 cannot only be used as the motive for forward movement of the ship, but also be used as the direction rudder of the ship.

As shown in FIG. 7, the anchor chain system 6 consists of gravity anchor 602 and anchor chain 601. The gravity anchor 602 sinks into the bottom of the sea, and one end of the anchor chain 601 is linked with the gravity anchor 602 and the other end is connected with the upper support 2, thus the ship can be fixed at certain position in the sea.

As shown in FIG. 8, wave detector system 9 consists of probe 901, computer 902, electric wire 903, the computer 902 connects with probe 901, and also connects with motor 111 and propeller 5. Probe 901 constantly detects the change of wave, and computer 902 calculates the average wavelength within certain time period, such as 1-5 minutes, then regularly adjust the distance 09 of two floating points 101 by changing the positive and negative rotating directions of the motor 111, so that it is as close as to the wavelength 010. So the turbine power generation system 3 installed in the middle of the support 2 can obtain the energy nearly two times of the wave height, thus generating the maximum power.

In case that the wave detector system 9 is not installed, manual clicking of the pushbutton can also change the positive and negative rotating directions of the motor 111, This involves manual control of the distance to the floating point 101, applicable for the small-sized power generating devices.

In the middle position 04 of wave amplitude power generating ship, there shall be two times of the wave height. The ship direction shall be consistent or nearly consistent with the wave direction, so that the floating bodies 120 on both ends can be in the peak as shown in 05 and in the valley as shown in 06, for which the ship direction shall be adjusted constantly.

Thus, the propeller 5 and computer 902 installed in the bottom of the ship make the power generating ship float in the designated sea area and make the positive direction of the hull is always in a straight line with the wave direction under the assistance of the satellite navigation, guaranteeing that the wave in the middle of the hull achieves the maximum amplitude.

### Implementation Example III

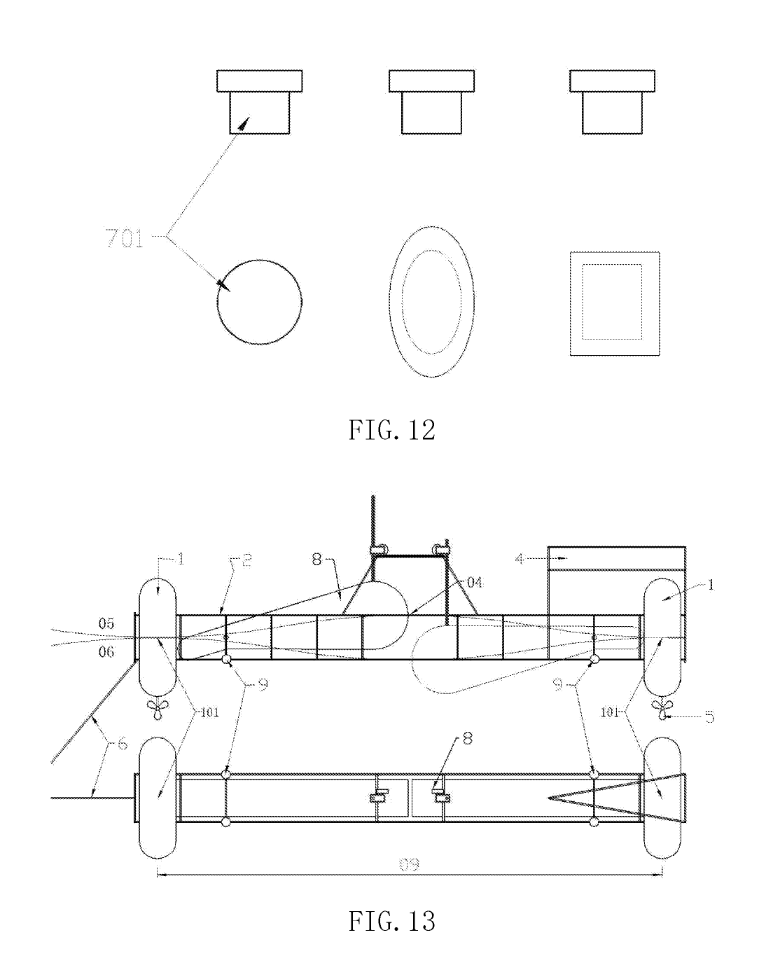

As shown in FIGS. 12 and 13, this implementation example consists of the floating body system 1, the support system 2, duck-type power generation system 8, wind rudder system 4, propeller 5, anchor chain system 6 and wave detector system 9.

As shown in FIG. 2, the floating body system 1 consists of the floating body 120, screw 110, motor 111, and nut 112. The floating body 120 is hollow and toroidal, and may also be toroidal and square ring shapes created by the polygonal shapes, such as square shape; the motor 111 is fixed on the support 2, the screw 110 is connected with the motor 111; and the nut 112 is fixed in the floating body 120. When the motor 111 is energized, it can realize rotation clockwise and counterclockwise; the rotation of the motor 111 will drive the rotation of the screw 110, whose rotation enables the adjustment of the distance from the nut 112 to the motor 11, while the motor 111 is fixed on the support 2, thus capable of adjusting the distance between the floating bodies 120 on both ends.

The said support system 2 is metallic frame, as shown in FIGS. 1 and 7.

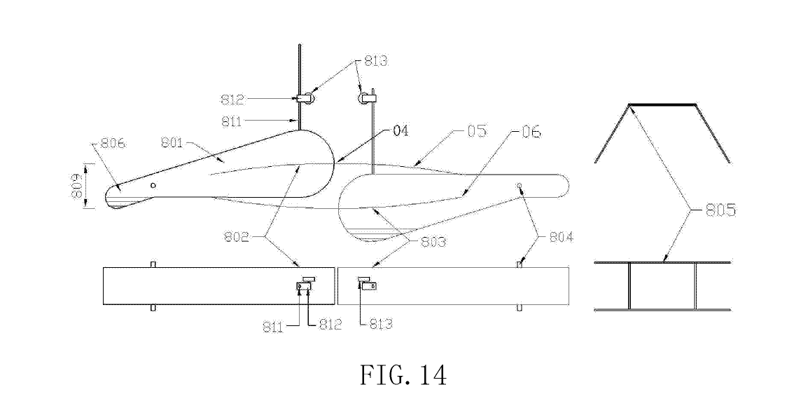

As shown in FIG. 14, the duck-type power generation system 8 consists of front duck body 801, rear duck body 806, supporting shaft 804, supporting frame 805, gear rack 811, gear rack and axial motion converter 812, and generator 813. The supporting shaft 804 is installed in the middle of front duck body 801 and rear duck body 806, and is jacketed with the bearing, which is fixed on the support system 2 in the position near the floating body 120. The front duck body 801 can make the circumferential motion around the supporting shaft 804; the supporting frame is welded on the support 2; the gear rack 811 is installed on the center of gravity of the duck head 802, and runs through gear rack and axial motion converter 812. The output shaft of gear rack and axial motion converter 812 is connected with the generator 813, gear rack and axial motion converter 812 and the generator 813 are fixed on the supporting frame 805 separately.

When the floating body 120 is in the valley, as in the situation of the wave 05, the middle position 04 of the support 2 is in the peak, then the center of gravity of the duck head 802 rises to the highest point, to drive the gear rack 811 to rise to the highest point; wave is in constant change, and the floating body 120 changes from the valley to peak, to drive the rise of the support 2, while the water level in the middle position 04 of the support 2 changes from peak to valley and the center of gravity of the duck head 802 also changes from the peak to valley with the wave. But the gear rack and axial motion converter 812 and generator 813 installed on the supporting frame 805 rise with the support 2, thus the gear rack 811 will produce the relative motion with the gear rack and axial motion converter 812, drive the rotation of the output shaft, thus driving the rotation of the generator 713 for power generation; the gear rack and axial motion converter 812 can change the linear motion of the gear rack 811 to the unidirectional rotation motion of the output shaft, meeting the need of the generator 813, thus capable of generating power; when the center of gravity of the duck head 802 changes to valley and is in the position of center of gravity of the duck head 803, then 809 represents its acting process; now the floating body 120 is in the peak, as the case in the situation of wave 06.

Wave is in constant change. The floating body 120 changes from peak to valley, as in the situation of wave 06, to drive the dropping of the support 2, while the water level in the middle position 04 of the support 2 changes form valley to peak. The center of gravity of the duck head 803 installed near the middle position 04 also changes from the valley to peak, while the gear rack and axial motion converter 812 and generator 813 installed on the supporting frame 805 fall with the support 2, thus gear rack 811 and gear rack and axial motion converter 812 will produce the relative motion, to drive the rotation of the output shaft, thus driving the rotating power generation by the generator 813. When center of gravity of the duck head 803 changes from the valley to peak, it is in the position of center of gravity of the duck head 803. At this moment, the center of gravity of the duck head 803 finishes one wave period; center of gravity of the duck head 803 repeats such circulation like this, and generator 813 can constantly generate power.

To increase the output power of the duck body, the duck body is a seesaw unit with the supporting shaft 804 as the centerline, consisting of front duck body 801 and rear duck body 806. The duck body is filled with water as the flowing weight, and water can flow between front duck body 801 and rear duck body 806. When the center of gravity of the duck head 802 is in the peak, water will suddenly flow to rear duck body 806, thus reducing the weight at the center of gravity of the duck head 802, so that the duck head 802 obtains maximum floating force for acting. Since water is in the other side 806 of the seesaw, it will increase the weight of the rear duck body 806 and make it drop; according to the lever principle, the center of gravity of the duck head 802 will rise, thus increasing the acting process.

When the center of gravity of the duck head 803 is situated in the valley, water will suddenly flow to the front duck body 801, to increase the weight at the center of gravity of the duck head 803, and increase the acting gravity of the floating body; at this moment, the center of gravity of the duck head 803 will also drop, thus increasing the acting process of the gravity.

One or 2-200 duck-type power generation systems 8 may be installed on the support system 2, with two systems shown in FIG. 12.

As shown in FIG. 7, the said wind rudder system 4 consists of framework 401 and canvas 402. The framework 401 is welded on the support 2, situated in or near the stern position. The anchor chain 601, support 2 and wind rudder 4 form a structure similar to the vane, and the hull of the ship looks like the vane, the stem drawn by the anchor chain 601 will just point to the coming direction of wind forever, while the wider rudder 4 will function as the tail of the vane, pointing to the running direction of wind, so that the direction of the support 2 is consistent with the coming direction of the wind always, thus consistent with the wave direction. Since the big wave is mostly caused by wind, its direction is basically consistent with that of wind.

Motorized ship direction adjustment: when the direction of the ship is consistent with that of the wave, probes 901 in the same position installed on both sides of the support 2 will sense the pressure of wave at the same time; when the direction of the ship is inconsistent with that of the wave, probes 901 on both sides of the support 2 will sense the pressure of wave not at the same time, when the computer 902 will automatically send the instruction to start propeller 5 in the bottom of the ship so that the ship makes the horizontal rotation movement, thus the direction of the ship is adjusted to be consistent with that of the wave; when the direction is consistent, the rotation of propeller 5 will be stopped. It is adjusted every 1-10 minutes, thus capable of constantly automatic adjustment to be consistent with the wave direction.

The said propeller 5 is of suspension type, capable of 360-degree rotation around the suspension shaft; so the propeller 5 cannot only be used as the motive for forward movement of the ship, but also be used as the direction rudder of the ship.

As shown in FIG. 7, the anchor chain system 6 consists of gravity anchor 602 and anchor chain 601. The gravity anchor 602 sinks into the bottom of the sea, and one end of the anchor chain 601 is linked with the gravity anchor 602 and the other end is connected with the upper support 2, thus the ship can be fixed at certain position in the sea.

As shown in FIG. 8, wave detector system 9 consists of probe 901, computer 902, electric wire 903, the computer 902 connects with probe 901, and also connects with motor 111 and propeller 5. Probe 901 constantly detects the change of wave, and computer 902 calculates the average wavelength within certain time period, such as 1-5 minutes, then regularly adjust the distance 09 of two floating points 101 by changing the positive and negative rotating directions of the motor 111, so that it is as close as to the wavelength 010. So the turbine power generation system 3 installed in the middle of the support 2 can obtain the energy nearly two times of the wave height, thus generating the maximum power.

In case that the wave detector system 9 is not installed, manual clicking of the pushbutton can also change the positive and negative rotating directions of the motor 111, This involves manual control of the distance to the floating point 101, applicable for the small-sized power generating devices.

In the middle position 04 of wave amplitude power generating ship, there shall be two times of the wave height. The ship direction shall be consistent or nearly consistent with the wave direction, so that the floating bodies 120 on both ends can be in the peak as shown in 05 and in the valley as shown in 06, for which the ship direction shall be adjusted constantly.

Thus, the propeller 5 and computer 902 installed in the bottom of the ship make the power generating ship float in the designated sea area and make the positive direction of the hull is always in a straight line with the wave direction under the assistance of the satellite navigation, guaranteeing that the wave in the middle of the hull achieves the maximum amplitude.

This invention is not limited to the abovementioned implementation examples or means. Once the distance 09 of two floating points 101 is as close as possible to the wavelength 010, it can make the ship obtain the acting with 1-2 times of wave height in the middle position 04 of the hull, thus falling into the protection scope of this invention. The distance to the floating point 101 is fixed or adjustable, also falling into the protection scope of this invention.

The above gives the detailed explanation of the priority implementation means and examples in combination with the attached drawings in this invention. But this invention is not limited to the abovementioned implementation means and examples, and the technical personnel in this field can make various changes within the scope of their knowledge under the premise of not deviating from the contemplation of this invention.

What is claimed is:

1. A wave amplitude power generating ship, consisting of the floating body system (1), the support system (2), turbine power generation system (3) or floating body power generation system (7) or duck-type power generation system (8), wind rudder system (4), propeller (5), anchor chain system (6) and wave detector system (9); characterized by:
The floating body system (1) is installed on both ends of the support system (2), and the distance may be adjusted;
The support system (2) undertakes all component systems;
Turbine power generation system (3) or floating body power generation system (7) or duck-type power generation system (8) is installed in the middle of the support system (2);
Wind rudder system (4) is installed on one end of the support system (2);
Propeller (5) is installed on the support system (2) or the floating body system (1);
Anchor chain system (6) is installed on the other end of the support system (2);
The wave detector system (9) is installed below the support system (2);

2. Wave amplitude power generating ship as described according to claim 1, which is characterized that, the said floating bodies (120) and (121) may be round, round-ring, spherical, polygonal, polygonal annular, or bow-shaped.

3. Wave amplitude power generating ship as described according to claim 1, which is characterized that, the distance of the said floating body (120) may be adjusted on the support system (2); it may be adjusted manually or in a power-driven manner.

4. Wave amplitude power generating ship as described according to claim 1, which is characterized that, the said floating body (121) may be integrated with the support system (2).

5. Wave amplitude power generating ship as described according to claim 1, which is characterized that, the gravity center of the said floating bodies (120) and (121), that is, the distance (09) from the floating point (101) is designed as almost equivalent to the average wavelength (010) of one wave in the sea area where the device runs, thus producing the wave height of 1-2 times in the middle of the ship (04).

6. Wave amplitude power generating ship as described according to claim 1, which is characterized that, the said support system (2) is installed with turbine power generation system (3), with the quantity of 1-200;

7. Wave amplitude power generating ship as described according to claim 1, which is characterized that, the said support system (2) is installed with the floating body power generation system (7), with the quantity of 1-200;
The shape of the said floating body (701) may be round, square or oval;
The draft of the said floating body (701) is bigger than 0.5-50 times of the short shaft or short length in the projection area of the floating body under the water level, and the projection area of the floating body above the water level is bigger than 30%-50 times of the projection area of the floating body below the water level;

8. Wave amplitude power generating ship as described according to claim 1, which is characterized that, duck-type power generation system (8) is installed in the middle of the said support system (2), with the quantity of 1-200;
The said duck body takes the supporting shaft (804) as the centerline, consisting of front duck body (801) and rear duck body (806); the duck body is filled with water to make the movable weight, so that water can flow between front duck body (801) and rear duck body (806);

9. Wave amplitude power generating ship as described according to claim 1, which is characterized that, the said wave detector system (9) is installed below the support system (2), or installed below floating body (120), with the quantity of 2-100.
